(19) United States
(12) Patent Application Publication
(10) Pub. No.: US 2026/0063760 A1
(43) Pub. Date: Mar. 5, 2026

(54) TELECOMMUNICATION SECTOR INTERFERENCE COUNTERMEASURES

(71) Applicant: RAKUTEN MOBILE, INC., Tokyo (JP)

(72) Inventors: Warangrat WIRIYA, Tokyo (JP); Bingxuan ZHAO, Tokyo (JP); Suguru SEKITA, Tokyo (JP); Shanfeng LI, Tokyo (JP); Toyokazu WATANABE, Tokyo (JP); Hyungmin HA, Tokyo (JP); Ryoji OSAKA, Tokyo (JP)

(73) Assignee: RAKUTEN MOBILE, INC., Tokyo (JP)

(21) Appl. No.: 18/820,540

(22) Filed: Aug. 30, 2024

(51) Int. Cl. G01S 7/40; G01S 7/02

(52) U.S. Cl. CPC G01S 7/403; G01S 7/023

(57) ABSTRACT

A method, apparatus, and system for sector interference countermeasures may be provided and may include, generating a list of azimuth and tilt values which may provide service to a target location for an NG sector of a site; and determining an optimal azimuth and tilt value with the lowest interference threshold and sufficient coverage, wherein determining comprises: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value

### FIELD

The present disclosure relates to sector interference countermeasures for telecommunication networks.

### BACKGROUND

The information disclosed in this background section is only for enhancement of understanding of the general background of the disclosure and should not be taken as an acknowledgement or any form of suggestion that this information forms the prior art already known to a person skilled in the art.

The interference coordination between mobile broadband networks (4G, 5G and beyond 5G) and another systems such as satellite systems must be considered because the mobile broadband systems may share the same frequency band or be in the adjacent frequency band with another systems. For mobile operation networks (MNO), in order to provide coverage to a larger area, a base station which refers as a site is often divided into multiple sectors or cells. Each sector has one or more antennas that can adjust a tilt (an angle of antenna in vertical plane) and azimuth (an angle of antenna in horizontal plane) to cover a specific geographical area.

In the related art, for a given site, interference may be present in or propagate from a given sector of the site, and in order to accommodate for the interference, a solution may be to adjust the tilt and azimuth of the antenna to reduce the interference. However in lowering interference with this method, there may be an inadvertent tradeoff leading to coverage loss for a location.

Related art systems may initially only be designed to set the tilt and azimuth of each sector based on a target service location and desired coverage level, without fully considering interference. Accordingly, one or more of the sectors for a given site may become NG (i.e., out of service) from the result of high interference to another systems. In some instances, even if the sectors have service, the transmission power may be low to reduce the harmful interference to another systems. Accordingly, there is a need for an improved method which can sufficiently account for both interference and coverage for a given site.

According to embodiments, methods, apparatuses and systems for sector interference countermeasures may be provided. The method may include, generating a list of azimuth and tilt values which may provide service to a target location for an NG sector of a site; and determining an optimal azimuth and tilt value with the lowest interference threshold and sufficient coverage, wherein determining comprises: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.

Based on the above embodiments, more NG sectors can be recovered since interference may be accounted for when designing azimuth and tilt. Accordingly, the cost for searching for a new location of a site may be reduced, and coverage may be increased to a wider population for a given site.

According to embodiments, an apparatus may be provided, the apparatus configured to generate a list of azimuth and tilt values for providing service to a target location for an NG sector of a site; and determine an optimal azimuth and tilt value with a lowest interference threshold and sufficient coverage, wherein the apparatus is configured to determine by: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.

According to embodiments, at least one non-transitory computer-readable recording medium may be provided having recorded thereon instructions executable to implement a method comprising: generating a list of azimuth and tilt values for providing service to a target location for an NG sector of a site; and determining an optimal azimuth and tilt value with a lowest interference threshold and sufficient coverage, wherein the determining comprises: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a flowchart for selecting tilt and azimuth based on simulated interference in a case with one or two NG sectors for a site according to an embodiment;

FIG. 2 illustrates a flowchart for selecting tilt and azimuth based on simulated interference in a case with all NG sectors for a site according to an embodiment;

FIG. 3 illustrates an example method for implementing sector interference countermeasures to select a tilt and azimuth with lowest interference and sufficient coverage according to an embodiment

FIG. 4 illustrates an example method for shortlisting a candidate list of tilt and azimuth values based on simulated interference according to an embodiment;

FIG. 5 is a diagram of an example environment in which systems and/or methods, described herein, may be implemented; and

FIG. 6 is a diagram of example components of a device according to an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

According to embodiments, methods, apparatuses and systems for sector interference countermeasures may be provided. The method may include, generating a list of azimuth and tilt values which may provide service to a target location for an NG sector of a site; and determining an optimal azimuth and tilt value with the lowest interference threshold and sufficient coverage, wherein determining comprises: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.

Based on the above embodiments, more NG sectors can be recovered since interference may be accounted for when designing azimuth and tilt. Accordingly, the cost for searching for a new location of a site may be reduced, and coverage may be increased to a wider population for a given site.

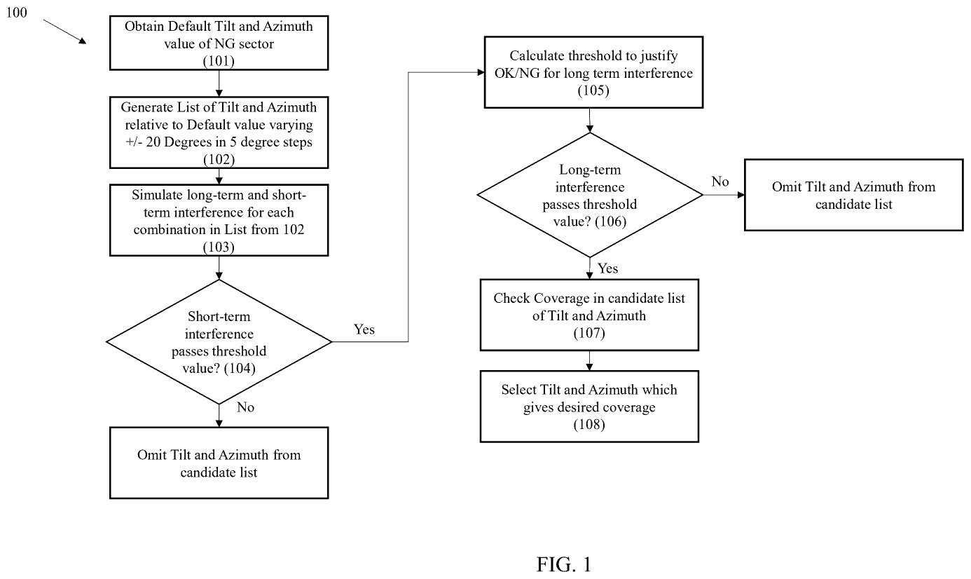

FIG. 1 illustrates a flowchart for selecting tilt and azimuth based on simulated interference in a case with one or two NG sectors for a site according to an embodiment.

According to embodiments, method 100 may be provided. Method 100 may be implemented in a case where one or two sectors for a given site (e.g., an earth station) are considered NG (e.g., no service). Accordingly, an algorithm may be implemented for method 100 which can obtain tilt and azimuth with lower interference, but the service area is unchanged from the previous setting.

At operation S101, a default value of tilt (down-tilt) and azimuth (direction of antenna) of the NG sector may be obtained. This may be the current tilt and azimuth value of the NG sector.

At operation S102, a candidate list of tilt and azimuth values which can provide the service to the same target location are obtained. Tilt and azimuth may be varied, for example, from −20 to +20 degree from the default value in operation S101. As illustrated in FIG. 1, this may be in 5 degree interval steps, however, it should be appreciated that the specific range and interval steps may be determined by a person skilled in the art.

An example machine code for implementing operation S102 may be as follows:

```
Vary_azimuth = Azimuth_default_value −20 : 5 : Azimuth_default_value −20;
Vary_tilt = Tilt_default_value −20 : 5 : Tilt_default_value −20;
Interested_azimuth_and_tilt = zeros(length(Vary_azimuth)* length(Vary_tilt),2);
t = 0;
for i = 1 : length(Vary_azimuth)
  for ii = 1 : length(Vary_tilt)
    t = t+1;
    Interested_azimuth_and_tilt(t,1) = Vary_azimuth(i);
    Interested_azimuth_and_tilt(t,2) = Vary_tilt (ii);
  end
```

At operation S103, a simulation may be run (for example, to simulate broadcast) using each combination of the tilt and azimuth values generated in operation S102. This is in order to check the interference for each combination of azimuth and tilt from operation S102.

It should be appreciated that interference may include long-term interference and short-term interference. Definitions for long-term interference and short-term interference may be defined based on a standard such as ITU-R P. 452. In particular, long-term interference may be that which that does not exceed long-term protection criterion and the short-term interference may be that which does not exceed short-term protection criterion. From ITU-R P. 452, the percentage of the time as a feature of the protection criterion may correspond to the time duration for which any exceedance of the interference threshold is permitted. From ITU-R P. 452, the long-term protection criterion may be defined at 20% of time, and the short-term protection criterion may be defined at 0.1% of time. Nevertheless, the specific definitions for long-term interference and short-term interference may depend on the specific implementation as determined by a person skilled in the art.

At operation S104, the interference determined for the simulation from each combination of tilt and azimuth from operation S103 may be compared relative to a short term interference threshold value. If the short term interference is lower than the short term interference threshold value for a given pair of tilt and azimuth, that pair of tilt and azimuth may proceed to the next step (operation S105) to check the long term interference, otherwise if not (i.e., the interference is greater than or equal to the threshold value), the pair may be omitted.

At operation S105, a long-term interference threshold value for one sector to select OK (acceptable) azimuth and tilt in terms of interference may be calculated. The long-term interference threshold value may be calculated based on a total number of sectors which are planned to be deployed, and an existing system threshold value. For instance, if the existing system is an earth station with a threshold value of xx dBm/MHz (wherein “xx” is an arbitrary value), and 10000 sectors are planned to be deployed in the coordination area of that earth station, the long-term interference threshold for one sector to select OK azimuth and tilt may be given by the following equation:

$$Threshold for One Sector = 10 \times {log}_{10} ( \frac{10 \hat{} ( \frac{Earth Station Threshold}{10} )}{Total Sectors} )$$

Using the example values, “earth station threshold” may be xx dBM/MHz, and “total sectors” may be 10000. It should be noted that the total interference which is not exceed the long-term protection criterion of the earth station is given by:

$$Earth Station Threshold < 10 * {log}_{10} ( Total Sectors \times 10 \hat{} ( \frac{Threshold for One Sector}{10} ) )$$

At operation S106, a shortlisted candidate list of azimuth and tilt values obtained based on operation S104 may be compared to the long-term interference threshold value calculated in operation S105. If the long-term interference is lower than the long-term interference threshold value for a given pair of tilt and azimuth, that pair of tilt and azimuth may proceed to the next step (operation S107) in order to check for coverage, otherwise if not (i.e., the interference is greater than or equal to the threshold value), the pair may be omitted.

At operation S107, the coverage for the pairs of tilt and azimuth in the further shortlisted candidate list of azimuth and tilt values based on operation S106 may be checked. For example, this may be by checking the transmission power relative to an acceptable transmission power threshold value.

At operation S108, based on checking the coverage in operation S107, the pair of tilt and azimuth which has the desired level of coverage to the target location may be selected.

There may be a sub-case for method 100 in which transmission power of one or two sector per site are low (for example, Equivalent isotropic radiated power (EIRP)=yy dBm (wherein “yy” is an arbitrary value)). In this scenario, the main target may be to increase the transmission power of the high interference sector. Accordingly, the threshold value (i.e., one of the interference threshold values) of one sector may be lowered (for example from 5-20 dB lower) depending on the desired level of transmission power to be increased. For example, if the threshold of one sector is −zz dBm/MHz (wherein “zz” is an arbitrary value), and we want to increase 5 dB of transmission power the threshold may be changed to −zz−5 dBm/MHz.

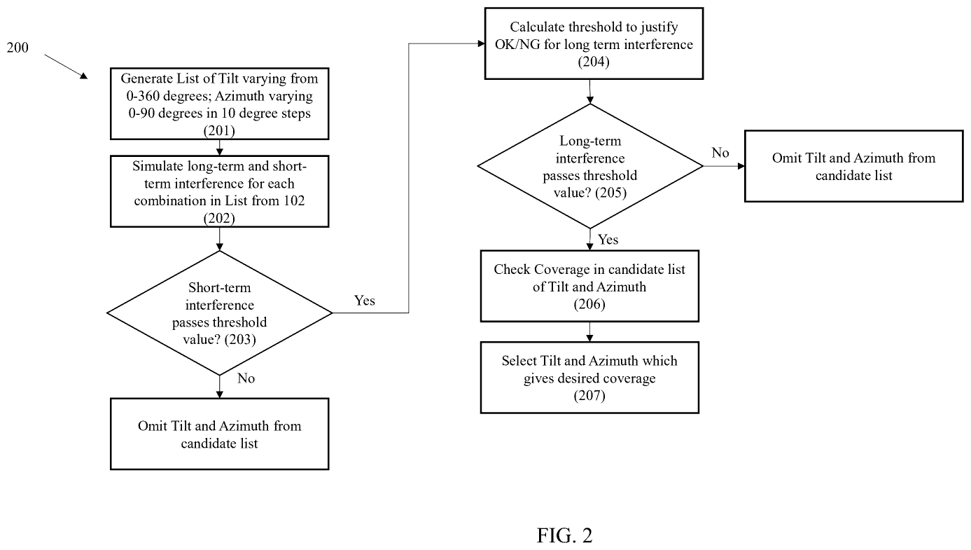

FIG. 2 illustrates a flowchart for selecting tilt and azimuth based on simulated interference in a case with all NG sectors for a site according to an embodiment.

According to embodiments, method 200 may be provided. Method 200 may be implemented in a case where all of the sectors for a given site are NG. Accordingly, an algorithm may be implemented for method 200 which can obtain tilt and azimuth with lower interference for all NG sectors.

At operation S201, a candidate list of tilt and azimuth values which can provide lower interference (but the service location might be changed) may be generated. In this scenario, azimuth may be varied from 0 to 360 degrees, and tilt may be varied from 0 to 90 degrees. As illustrated in FIG. 2, this may be in 10 degree interval steps, however, it should be appreciated that the specific range and interval steps may be determined by a person skilled in the art.

An example machine code for implementing operation S201 may be as follows:

```
Vary_azimuth = 0:10:360;
Vary_tilt = 0:10:90;
Interested_azimuth_and_tilt = zeros(length(Vary_azimuth)* length(Vary_tilt),2);
t = 0;
for i = 1 : length(Vary_azimuth)
  for ii = 1 : length(Vary_tilt)
    t = t+1;
    Interested_azimuth_and_tilt(t,1) = Vary_azimuth(i);
    Interested_azimuth_and_tilt(t,2) = Vary_tilt (ii);
  end
end
```

Operations S202 through S207 may be the same as operations S103 through S108 from FIG. 1 respectively, as previously described above. Accordingly, the same descriptions are omitted for conciseness.

There may be a sub-case for method 200 in which transmission power of all sectors per site are low (for example, EIRP=45 dBm). In this scenario the threshold value (i.e., one of the interference threshold values) of one sector may be lowered (for example, from 5-20 dB lower) depending on the desired level of transmission power to be increased.

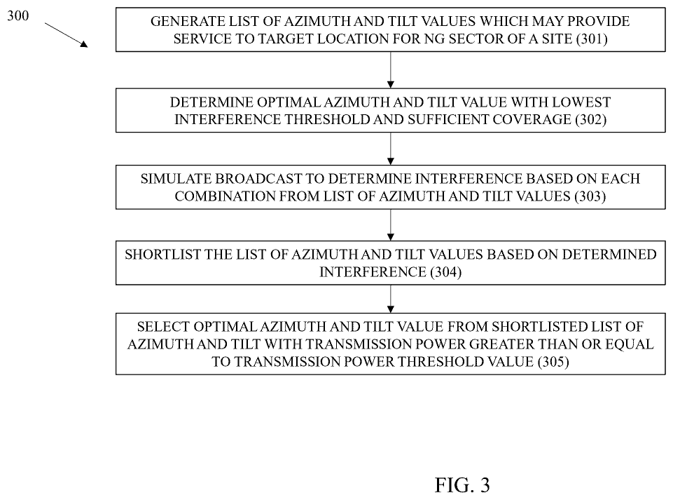

FIG. 3 illustrates an example method 300 for implementing sector interference countermeasures to select a tilt and azimuth with lowest interference and sufficient coverage according to an embodiment

At operation S301, a list of azimuth and tilt values which may provide service to target location for an NG sector or a given site may be generated. This may be, for example, an array of azimuth and tilt value pairs over a given range with described step intervals.

At operation S302, the optimal azimuth and tilt value with lowest interference threshold and sufficient coverage may be determined. Operation S302 may comprise Operations S303 through S305 as described below:

At operation S303, a broadcast may be simulated to determine interference based on each combination from the list of azimuth and tilt values generated in operation S301. The simulation may be implemented using an appropriate method by a person skilled in the art.

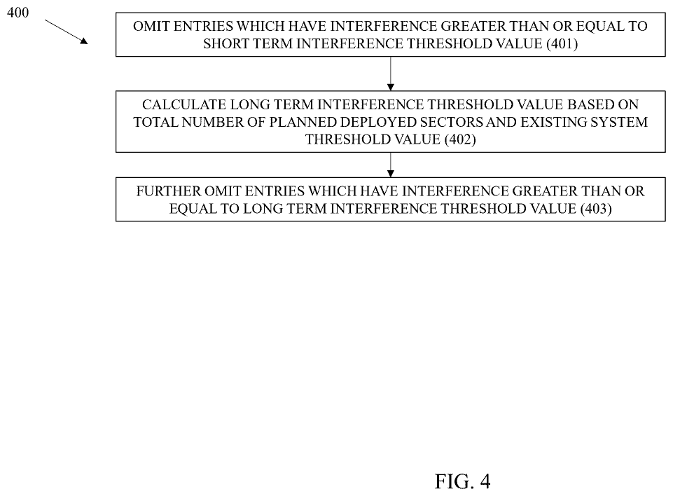

At operation S304, the list of azimuth and tilt values may be shortlisted based on the determined interference from operation S303. Further possible steps for the shortlisting may be described with reference to FIG. 4 below.

At operation S305, an optimal azimuth and tilt value from the shortlisted list of azimuth and tilt values with transmission power greater than or equal to a transmission power threshold value may be selected. That is, sufficient coverage may be determined based on the transmission power being above a desired level.

FIG. 4 illustrates an example method 400 for shortlisting a candidate list of tilt and azimuth values based on simulated interference according to an embodiment. Method 400 may be a sub-step of operation S304 described with reference to FIG. 3 described above.

At operation S401, entries which have interference greater than or equal to a short term interference threshold value may be omitted.

At operation S402, a long term interference threshold value based on a total number of planned deployed sectors and existing system threshold value may be calculated. As explained with reference to operation S105 in FIG. 1, this may be given by an equation as follows:

$$Threshold for One Sector = 10 \times {log}_{10} ( \frac{10 \hat{} ( \frac{Earth Station Threshold}{10} )}{Total Sectors} )$$

At operation S403, entries which have interference greater than or equal to a long term interference threshold value may be omitted.

Based on the above embodiments, more NG sectors can be recovered since interference may be accounted for when designing azimuth and tilt. Accordingly, the cost for searching for a new location of a site may be reduced, and coverage may be increased to a wider population for a given site.

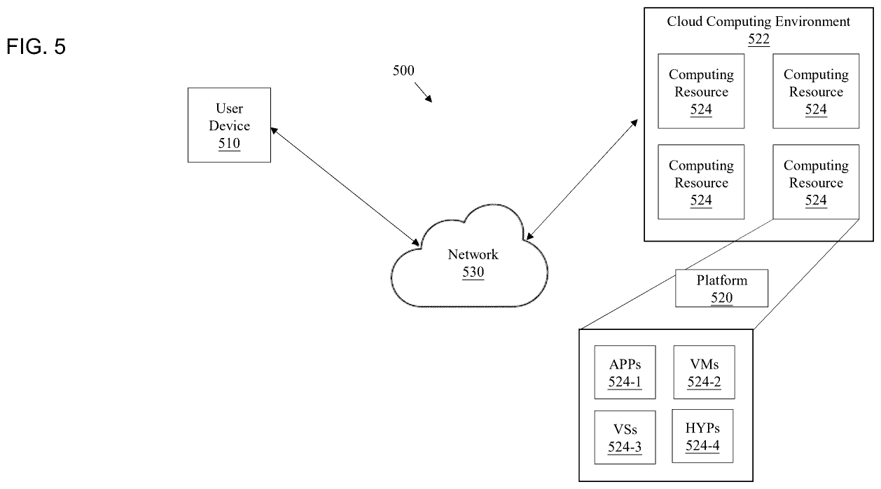

FIG. 5 is a diagram of an example environment 500 in which systems and/or methods, described herein, may be implemented. As shown in FIG. 5, environment 500 may include a user device 510, a platform 520, and a network 530. Devices of environment 500 may interconnect via wired connections, wireless connections, or a combination of wired and wireless connections. In embodiments, any of the functions and operations described with reference to FIGS. 1-4 above may be performed by any combination of elements illustrated in FIG. 5.

User device 510 includes one or more devices capable of receiving, generating, storing, processing, and/or providing information associated with platform 520. For example, user device 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 510 may receive information from and/or transmit information to platform 520.

Platform 520 includes one or more devices capable of receiving, generating, storing, processing, and/or providing information. In some implementations, platform 520 may include a cloud server or a group of cloud servers. In some implementations, platform 520 may be designed to be modular such that certain software components may be swapped in or out depending on a particular need. As such, platform 520 may be easily and/or quickly reconfigured for different uses.

In some implementations, as shown, platform 520 may be hosted in cloud computing environment 522. Notably, while implementations described herein describe platform 520 as being hosted in cloud computing environment 522, in some implementations, platform 520 may not be cloud-based (i.e., may be implemented outside of a cloud computing environment) or may be partially cloud-based.

Cloud computing environment 522 includes an environment that hosts platform 520. Cloud computing environment 522 may provide computation, software, data access, storage, etc., services that do not require end-user (e.g., user device 510) knowledge of a physical location and configuration of system(s) and/or device(s) that hosts platform 520. As shown, cloud computing environment 522 may include a group of computing resources 524 (referred to collectively as “computing resources 524” and individually as “computing resource 524”).

Computing resource 524 includes one or more personal computers, a cluster of computing devices, workstation computers, server devices, or other types of computation and/or communication devices. In some implementations, computing resource 524 may host platform 520. The cloud resources may include compute instances executing in computing resource 524, storage devices provided in computing resource 524, data transfer devices provided by computing resource 524, etc. In some implementations, computing resource 524 may communicate with other computing resources 524 via wired connections, wireless connections, or a combination of wired and wireless connections.

As further shown in FIG. 5, computing resource 524 includes a group of cloud resources, such as one or more applications (“APPs”) 524-1, one or more virtual machines (“VMs”) 524-2, virtualized storage (“VSs”) 524-3, one or more hypervisors (“HYPs”) 524-4, or the like.

Application 524-1 includes one or more software applications that may be provided to or accessed by user device 510. Application 524-1 may eliminate the need to install and execute the software applications on user device 510. For example, application 524-1 may include software associated with platform 520 and/or any other software capable of being provided via cloud computing environment 522. In some implementations, one application 524-1 may send/receive information to/from one or more other applications 524-1, via virtual machine 524-2.

Virtual machine 524-2 includes a software implementation of a machine (e.g., a computer) that executes programs like a physical machine. Virtual machine 524-2 may be either a system virtual machine or a process virtual machine, depending upon use and degree of correspondence to any real machine by virtual machine 524-2. A system virtual machine may provide a complete system platform that supports execution of a complete operating system (“OS”). A process virtual machine may execute a single program, and may support a single process. In some implementations, virtual machine 524-2 may execute on behalf of a user (e.g., user device 510), and may manage infrastructure of cloud computing environment 522, such as data management, synchronization, or long-duration data transfers.

Virtualized storage 524-3 includes one or more storage systems and/or one or more devices that use virtualization techniques within the storage systems or devices of computing resource 524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 524-4 may provide hardware virtualization techniques that allow multiple operating systems (e.g., “guest operating systems”) to execute concurrently on a host computer, such as computing resource 524. Hypervisor 524-4 may present a virtual operating platform to the guest operating systems and may manage the execution of the guest operating systems. Multiple instances of a variety of operating systems may share virtualized hardware resources.

Network 530 includes one or more wired and/or wireless networks. For example, network 530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

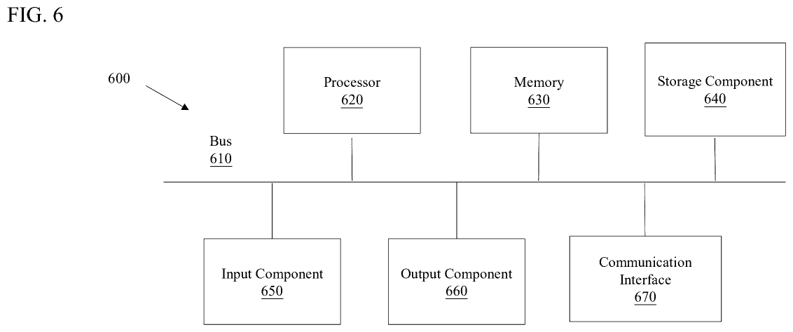

FIG. 6 illustrates an embodiment of a device 600. As shown in FIG. 6, the device 600 processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single core processor, or a combination of one or more multi-core processors and/or one or more single core processors, a distributed processing system, or the like. The processor 610 may be a Central Processing Unit (CPU) a graphics processing unit (GPU), an accelerated processing unit (APU), an application-specific integrated circuit (ASIC), or another type of processing component.

Memory 620 includes a non-transitory computer readable medium. Memory 620 includes a random-access memory (RAM), a read only memory (ROM), and/or another type of dynamic or static storage device (e.g., a flash memory, a magnetic memory, and/or an optical memory) that stores information and/or instructions for use by processor 610. The memory 620 comprises machine-readable instructions which are executable by the processor 610. These machine-readable instructions when executed by the processor 610 cause the processor 610 to perform one or more method steps of an embodiment described above.

Storage component 630 stores information and/or software related to the operation and use of the device 600. For example, storage component 630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a global positioning system (GPS), an accelerometer, a gyroscope, and/or an actuator).

Output component 650 is configured to provide output information from the device 600. For example, the output component 650 may be, but not limited to, a display, a speaker, instructions to an external device, and/or one or more light-emitting diodes (LEDs).

Communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600. Further, one or more method steps described in any of the embodiments may be performed utilizing a plurality of devices 600 in communication with one another.

In embodiments, any one of the operations or processes of FIGS. 1-4 may be implemented by or using any one of the elements illustrated in FIGS. 5 and 6. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1] A method including: generating a list of azimuth and tilt values which may provide service to a target location for an NG sector of a site; and determining an optimal azimuth and tilt value with the lowest interference threshold and sufficient coverage, wherein determining includes: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.
Item [2]: The method according to Item [1], wherein shortlisting the list of azimuth and tilt values based on the determined interference includes: omitting entries which have interference greater than or equal to a short term interference threshold value; and further omitting entries which have interference greater than or equal to a long term interference threshold value.
Item [3]: The method according to Item [2], wherein the long term interference threshold value may be calculated based on a total number of planned deployed sectors and an existing system threshold value.
Item [4]: The method according to Item [3], wherein one or two sectors of the site are NG, and the generated list of azimuth and tilt values includes combinations of azimuth and tilt values from −20 degrees up to +20 degrees relative to a default azimuth and tilt value for the NG sector in step intervals.
Item [5]: The method according to Item [4], wherein if the transmission power of the one or two sectors of the site are low, the method further includes: lowering the long term interference threshold value or the short term interference threshold value of one sector of the site which has the highest interference.
Item [6]: The method according to Item [3], wherein all sectors of the site are NG, and the generated list of azimuth and tilt values comprise combinations of azimuth values from 0 to 360 degrees and tilt values from 0 to 90 degrees in step intervals.
Item [7]: The method according to Item [6], wherein if the transmission power of all sectors of the site are low, the method further includes: lowering the long term interference threshold value or a short term interference threshold value of one sector of any one sector of the site.
Item [8]: An apparatus configured to: generate a list of azimuth and tilt values for providing service to a target location for an NG sector of a site; and determine an optimal azimuth and tilt value with a lowest interference threshold and sufficient coverage, wherein the apparatus is configured to determine by: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.
Item [9]: The apparatus according to Item [8], wherein the apparatus is configured to shortlist the list of azimuth and tilt values based on the determined interference by: omitting entries which have interference greater than or equal to a short term interference threshold value; and further omitting entries which have interference greater than or equal to a long term interference threshold value.
Item [10]: The apparatus according to Item [9], wherein the long term interference threshold value is calculated based on a total number of planned deployed sectors and an existing system threshold value.
Item [11]: The apparatus according to Item [10], wherein one or two sectors of the site are NG, and the generated list of azimuth and tilt values includes combinations of azimuth and tilt values from −20 degrees up to +20 degrees relative to a default azimuth and tilt value for the NG sector in step intervals.
Item [12]: The apparatus according to Item [11], wherein if the transmission power of the one or two sectors of the site are low, the apparatus is further configured to: lower the long term interference threshold value or the short term interference threshold value of one sector of the site which has the highest interference.
Item [13]: The apparatus according to Item [10], wherein all sectors of the site are NG, and the generated list of azimuth and tilt values comprise combinations of azimuth values from 0 to 360 degrees and tilt values from 0 to 90 degrees in step intervals.
Item [14]: The apparatus according to Item [13], wherein if the transmission power of all sectors of the site are low, the apparatus is further configured to: Lower the long term interference threshold value or the short term interference threshold value of one sector of the site which has the highest interference.
Item [15]: At least one non-transitory computer-readable recording medium having recorded thereon instructions executable to implement a method including: generating a list of azimuth and tilt values for providing service to a target location for an NG sector of a site; and determining an optimal azimuth and tilt value with a lowest interference threshold and sufficient coverage, wherein the determining includes: simulating broadcast to determine interference based on each combination from the list of azimuth and tilt values; shortlisting the list of azimuth and tilt values based on the determined interference; and selecting the optimal azimuth and tilt value from the shortlisted list of azimuth and tilt values which has transmission power greater than or equal to a transmission power threshold value.
Item [16]: The at least one non-transitory computer-readable recording medium according to Item [15], wherein shortlisting the list of azimuth and tilt values based on the determined interference includes: omitting entries which have interference greater than or equal to a short term interference threshold value; and further omitting entries which have interference greater than or equal to a long term interference threshold value.
Item [17]: The at least one non-transitory computer-readable recording medium according to Item [16], wherein the long term interference threshold value is calculated based on a total number of planned deployed sectors and an existing system threshold value.
Item [18]: The at least one non-transitory computer-readable recording medium according to Item [17], wherein one or two sectors of the site are NG, and the generated list of azimuth and tilt values includes combinations of azimuth and tilt values from −20 degrees up to +20 degrees relative to a default azimuth and tilt value for the NG sector in step intervals.
Item [19]: The at least one non-transitory computer-readable recording medium according to Item [18], wherein if the transmission power of the one or two sectors of the site are low, the method further includes: lowering the long term interference threshold value or the short term interference threshold value of one sector of the site which has the highest interference.
Item [20]: The at least one non-transitory computer-readable recording medium according to Item [17], wherein all sectors of the site are NG, and the generated list of azimuth and tilt values comprise combinations of azimuth values from 0 to 360 degrees and tilt values from 0 to 90 degrees in step intervals, wherein if the transmission power of all sectors of the site are low, the method further includes: lowering the long term interference threshold value or the short term interference threshold value of one sector of the site which has the highest interference.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
generating a list of azimuth and tilt values for providing service to a target location for an NG sector of a site; and
determining an optimal azimuth and tilt value with a lowest interference threshold and sufficient coverage, wherein the determining comprises:
simulating broadcast to determine interference based on each combination from the list of azimuth and tilt values;
shortlisting the list of azimuth and tilt values based on the determined interference; and
selecting the optimal azimuth and tilt value from the shortlisted list of azimuth and tilt values which has transmission power greater than or equal to a transmission power threshold value.

2. The method as claimed in claim 1, wherein shortlisting the list of azimuth and tilt values based on the determined interference comprises:
omitting entries which have interference greater than or equal to a short term interference threshold value; and
further omitting entries which have interference greater than or equal to a long term interference threshold value.

3. The method as claimed in claim 2, wherein the long term interference threshold value is calculated based on a total number of planned deployed sectors and an existing system threshold value.

4. The method as claimed in claim 3, wherein one or two sectors of the site are NG, and the generated list of azimuth and tilt values comprises combinations of azimuth and tilt values from −20 degrees up to +20 degrees relative to a default azimuth and tilt value for the NG sector in step intervals.

5. The method as claimed in claim 4, wherein if the transmission power of the one or two sectors of the site are low, the method further comprises:
lowering the long term interference threshold value or the short term interference threshold value of one sector of the site which has the highest interference.

6. The method as claimed in claim 3, wherein all sectors of the site are NG, and the generated list of azimuth and tilt values comprise combinations of azimuth values from 0 to 360 degrees and tilt values from 0 to 90 degrees in step intervals.

7. The method as claimed in claim 6, wherein if the transmission power of all sectors of the site are low, the method further comprises:
lowering the long term interference threshold value or the short term interference threshold value of one sector of the site which has the highest interference.

8. An apparatus configured to:
generate a list of azimuth and tilt values for providing service to a target location for an NG sector of a site; and
determine an optimal azimuth and tilt value with a lowest interference threshold and sufficient coverage, wherein the apparatus is configured to determine by:
simulating broadcast to determine interference based on each combination from the list of azimuth and tilt values;
shortlisting the list of azimuth and tilt values based on the determined interference; and
selecting the optimal azimuth and tilt value from the shortlisted list of azimuth and tilt values which has transmission power greater than or equal to a transmission power threshold value.

9. The apparatus as claimed in claim 8, wherein the apparatus is configured to shortlist the list of azimuth and tilt values based on the determined interference by:
omitting entries which have interference greater than or equal to a short term interference threshold value; and
further omitting entries which have interference greater than or equal to a long term interference threshold value.

10. The apparatus as claimed in claim 9, wherein the long term interference threshold value is calculated based on a total number of planned deployed sectors and an existing system threshold value.

11. The apparatus as claimed in claim 10, wherein one or two sectors of the site are NG, and the generated list of azimuth and tilt values comprises combinations of azimuth and tilt values from −20 degrees up to +20 degrees relative to a default azimuth and tilt value for the NG sector in step intervals.

12. The apparatus as claimed in claim 11, wherein if the transmission power of the one or two sectors of the site are low, the apparatus is further configured to:
lower the long term interference threshold value or the short term interference threshold value of one sector of the site which has the highest interference.

13. The apparatus as claimed in claim 10, wherein all sectors of the site are NG, and the generated list of azimuth and tilt values comprise combinations of azimuth values from 0 to 360 degrees and tilt values from 0 to 90 degrees in step intervals.

14. The apparatus as claimed in claim 13, wherein if the transmission power of all sectors of the site are low, the apparatus is further configured to:
Lower the long term interference threshold value or the short term interference threshold value of one sector of the site which has the highest interference.

15. At least one non-transitory computer-readable recording medium having recorded thereon instructions executable to implement a method comprising:
generating a list of azimuth and tilt values for providing service to a target location for an NG sector of a site; and
determining an optimal azimuth and tilt value with a lowest interference threshold and sufficient coverage, wherein the determining comprises:
simulating broadcast to determine interference based on each combination from the list of azimuth and tilt values;
shortlisting the list of azimuth and tilt values based on the determined interference; and
selecting the optimal azimuth and tilt value from the shortlisted list of azimuth and tilt values which has transmission power greater than or equal to a transmission power threshold value.

16. The at least one non-transitory computer-readable recording medium as claimed in claim 15, wherein shortlisting the list of azimuth and tilt values based on the determined interference comprises:
omitting entries which have interference greater than or equal to a short term interference threshold value; and
further omitting entries which have interference greater than or equal to a long term interference threshold value.

17. The at least one non-transitory computer-readable recording medium as claimed in claim 16, wherein the long term interference threshold value is calculated based on a total number of planned deployed sectors and an existing system threshold value.

18. The at least one non-transitory computer-readable recording medium as claimed in claim 17, wherein one or two sectors of the site are NG, and the generated list of azimuth and tilt values comprises combinations of azimuth and tilt values from −20 degrees up to +20 degrees relative to a default azimuth and tilt value for the NG sector in step intervals.

19. The at least one non-transitory computer-readable recording medium as claimed in claim 18, wherein if the transmission power of the one or two sectors of the site are low, the method further comprises:
lowering the long term interference threshold value or the short term interference threshold value of one sector of the site which has the highest interference.

20. The at least one non-transitory computer-readable recording medium as claimed in claim 17, wherein all sectors of the site are NG, and the generated list of azimuth and tilt values comprise combinations of azimuth values from 0 to 360 degrees and tilt values from 0 to 90 degrees in step intervals, wherein if the transmission power of all sectors of the site are low, the method further comprises:
lowering the long term interference threshold value or the short term interference threshold value of one sector of the site which has the highest interference.
